(19) United States
(12) Patent Application Publication
(10) Pub. No.: US 2025/0005611 A1
(43) Pub. Date: Jan. 2, 2025

(54) SYSTEM AND METHOD FOR SUPPLY CHAIN OPTIMIZATION

(71) Applicant: Kinaxis Inc., Ottawa (CA)

(72) Inventors: Dan VLASIE, Quincy, MA (US); Carsten JORDAN, San Diego, CA (US); Ingrid BONGARTZ, Ottawa (CA); Sergei KRUTELEVICH, Ottawa (CA); Yankai ZHANG, Ottawa (CA)

(21) Appl. No.: 18/754,644

(22) Filed: Jun. 26, 2024

Related U.S. Application Data
(60) Provisional application No. 63/510,390, filed on Jun. 27, 2023.

(51) Int. Cl. G06Q 30/0202

(52) U.S. Cl. CPC G06Q 30/0202

(57) ABSTRACT

A system and method for supply chain optimization include receiving, by a processor, a modelled supply chain having one or more finished or semi-finished goods at one or more top levels and, for each of the one or more finished or semi-finished goods, a complementary set of component products at one or more bottom levels, performing, by the processor, a top-down heuristic operation on the modelled supply chain to determine demands at the one or more bottom levels, formulating, by the processor, optimized model for the one or more bottom levels based on the determined demands, and solving, by the processor, the optimized model to generate optimized results.

### BACKGROUND

Supply chain optimization processes typically involve a global solving approach over the entire supply chain. Such approaches can be computationally demanding in terms of computing time, computer processing requirements, and computer memory requirements, making such supply chain optimization processes unfeasible for certain computer systems to perform.

### BRIEF SUMMARY

The details of one or more embodiments of the subject matter of this specification are set forth in the accompanying drawings and the description below. Other features, aspects, and advantages of the subject matter may become apparent from the description, the drawings, and the claims.

The present disclosure describes a supply chain optimization process that utilizes a combination of heuristics and optimization to determine a solution to a modelled supply chain. Utilizing a combination of heuristic and optimization may be beneficial in the case of supply chains with numerous but simpler top-level products and with relatively few, more complex, bottom-level components.

In general, a modelled supply chain consists of parts representing finished goods, semi-finished goods, sub-assemblies and components; relationships among those parts, giving the quantities, lead times and resources required to transform lower-level parts into higher-level parts; and demands for finished goods or semi-finished goods over multiple periods. The modelled supply chain models, for example, parts, sites, capacitated work-centers and resources, bills of material, inventories, and in general complex production processes with time variability, lot sizing, lead times, substitutions, yields, scraps.

The solution to an overall supply chain problem results from determining or calculating supplies for all parts throughout the modelled supply chain. The calculated supplies for a part may include, for example, availability date, quantities, chosen production methods where more than one method is available, and allocation of that part.

Criteria that may be utilized in determining the solution to the overall supply chain problem may include, for example, demand satisfaction, safety stock levels and various costs, such as production holding, revenue, substitution costs.

In such situations, a global optimization process may spend significant computational resources in terms of, for example, time and memory space, on the less complex but numerous nature of the top-level production processes, while a pure heuristic approach may not provide an overall good solution in the presence of more complex production processes at the bottom levels of the supply chain.

In an embodiment, the disclosed supply chain optimization method or process uses optimization to solve a subset of the modelled supply chain, and uses heuristics to solve another subset of the modelled supply chain. This combination of optimization and heuristics reduces the computational demands, such as computing time, computer memory, and processor resources, compared to a global solving approach using only optimization, while still producing comparable high-quality solutions, particularly when compared to a purely heuristic solution.

Given the less constraining capacities at the top levels, demands may be determined heuristically starting from the top-level product demands down to the bottom levels of the supply chain, which may be referred to as a top-down heuristic operation. The top-down heuristic operation may provide a sufficiently accurate initial determination of the demands of the modelled supply chain, which may be utilized as a starting point to reduce the computational requirements of performing a subsequent optimization at the more complex production processes at the bottom levels of the supply chain.

In the present disclosure, a modelled supply chain may be partitioned into a set of products at the top levels, which may be referred to as the heuristic levels, and a complementary set of component products at the bottom levels, which may be referred to as the optimization levels. Then, a top-down heuristic operation or method, for example utilizing a heuristic algorithm, may be applied to determine demands at the optimization levels from the top levels. Next, an optimization operation, for example utilizing an optimization algorithm, may be applied to the optimization levels using the demands determined by the top-down heuristics operation as inputs to formulate and solve an optimized supply chain model. A subsequent heuristics operation may be performed, starting from the bottom levels of the supply chain up to the top levels, which may be referred to as a bottom-up heuristic operation, may then be performed on the results of the optimization operation.

In one aspect, the present disclosure provides a computer-implemented method that comprises: receiving, by a processor, a modelled supply chain having one or more finished or semi-finished goods at one or more top levels and, for each of the one or more finished or semi-finished goods, a complementary set of component products at one or more bottom levels; performing, by the processor, a top-down heuristic operation on the modelled supply chain to determine demands at the one or more bottom levels; formulating, by the processor, an optimized model for the one or more bottom levels based on the determined demands; and solving, by the processor, the optimized model to generate optimized results.

The computer-implemented method may further include performing, by the processor, a bottom-up heuristic operation on the results of the optimization operation to determine information associated with demands and supplies of the one or more top levels.

In the computer-implemented method, the information associated with the demands of the one or more top levels may comprise the satisfaction date, or supply allocations, or both, for the demands and supplies at the one or more top levels.

In another aspect, the present disclosure provides a system that includes a processor and a memory storing instructions that, when executed by the processor, configure the system to: receive, by the processor, a modelled supply chain having one or more finished or semi-finished goods at one or more top levels and, for each of the one or more finished or semi-finished goods, a complementary set of component products at one or more bottom levels; perform, by the processor, a top-down heuristic operation on the modelled supply chain to determine demands at the one or more bottom levels; formulate, by the processor, an optimized model for the one or more bottom levels based on the determined demands; and solve, by the processor, the optimized model to generate optimized results.

In the system, the memory may store instructions that, when executed by the processor, configure the system to perform, by the processor, a bottom-up heuristic operation on the results of the optimization operation to determine information associated with demands and supplies of the one or more top levels.

In the system, the information associated with the demands of the one or more top levels may include the satisfaction date, or supply allocations, or both, for the demands and supplies at the one or more top levels.

In another aspect, the present disclosure provides a non-transitory computer-readable medium, the computer-readable medium including instructions that when executed by a computer, cause the computer to: receive, by a processor, a modelled supply chain having one or more finished or semi-finished goods at one or more top levels and, for each of the one or more finished or semi-finished goods, a complementary set of component products at one or more bottom levels; perform, by the processor, a top-down heuristic operation on the modelled supply chain to determine demands at the one or more bottom levels; formulate, by the processor, optimized model for the one or more bottom levels based on the determined demands; and solve, by the processor, the optimized model to generate optimized results.

The non-transitory computer-readable medium may include further instructions that, when executed by the computer, cause the computer to perform, by the processor, a bottom-up heuristic operation on the results of the optimization model to determine information associated with demands and supplies of the one or more top levels.

The non-transitory computer-readable medium may include that the information associated with the demands of the one or more top levels is the satisfaction date, or supply allocations, or both, for the demands and supplies at the one or more top levels.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for supply chain optimization in accordance with one embodiment.

FIG. 2 illustrates a flow chart of an example computer implemented method for supply chain optimization in accordance with one embodiment.

### DETAILED DESCRIPTION

Supply chain management refers to the handling of the production flow of a good or service. Supply chain management may include a modelled supply chain that includes the raw component products at the lower levels, and the finished good or service that are assembled from the raw component products at the top levels.

Conventional supply chain optimization processes typically include a global solving approach that attempts to optimize the entire modelled supply chain at once.

One such global solving approach uses an optimization algorithm. Supply chain optimization processes that utilize optimization algorithms can be computationally demanding in terms of computing time, processing requirements, and computer memory requirements. Such computation demands may result in certain computer systems being unable to perform supply chain optimization processes because utilizing the conventional global solving approach would be unfeasible in real world situations due to the computation resources, such as, for example, the computation time and the memory resources, that would be required.

Another such global solving approach uses a heuristic algorithm. Such purely heuristic approaches may proceed by first figuring out demands from the top levels all the way down to the bottom levels, followed by figuring out satisfaction dates while allocating supplies to demands from bottom levels to top levels. Supply chain optimization processes that utilize heuristic algorithms have the challenge that the heuristic algorithm may not find the optimal solution and is typically unable to account for multiple competing objectives when determining a solution. This may be undesirable when solving complex supply chain problems, particularly with the complex production processes that are included at the bottom levels of the supply chain in some industries, as described below.

The present disclosure provides a system and method that addresses a distinct category of supply chain optimization problems in supply chains associated with the assembly of numerous finished and semi-finished goods at the top levels of the modelled supply chain, for example from a relatively small set of common components and sub-components at the lower levels. “Relatively small” in this context may refer to a ratio of components at the bottom level vs finished products at the top level.

One example of a suitable application may be where the same finished product is packaged in numerous SKUs, where the SKU distinction is given by, for example, the package sizing, presentation, labels, or language. Here there are numerous different end products at the top level of the modelled supply chain, i.e., the different SKUs, that come from the same set of input products at the bottom levels of the modelled supply chain.

Another example of a suitable application may be in a pharmaceutical context where many finished goods at the top level of the modelled supply chain are produced from limited supplies of a few key ingredients such as, for example, blood plasma. It this example, it may be important to fractionate the blood plasma in the optimal way, among a myriad of possibilities, to satisfy as many demands as possible.

Generally, in these targeted problems, production processes at the top levels of the supply chain may be characterized by fewer alternate production methods, fewer substitutable parts, and fewer capacity constraints shared among the parts. Such limited flexibility in the top levels of the modelled supply chain results in a supply chain problem suitable for solving using a rules-based operation, such as a heuristic algorithm, which are most suitable when there are few choices to be made in the supply chain.

The lower levels of the modelled supply chain in these targeted problems may be characterized by more alternate production methods, more substitutable parts, and more shared capacity constraints among the parts. Optimization performs better, compared to heuristics, when there are many solution paths in the supply chain, by evaluating the trade-offs among the many alternative solution paths and calculating the best set of supplies to satisfy demands, based on the weighted costs in the objective function. Thus, the alternative solution paths available at the lower levels of the modelled supply chain favours the use of optimization algorithms for solving supply chain problems.

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

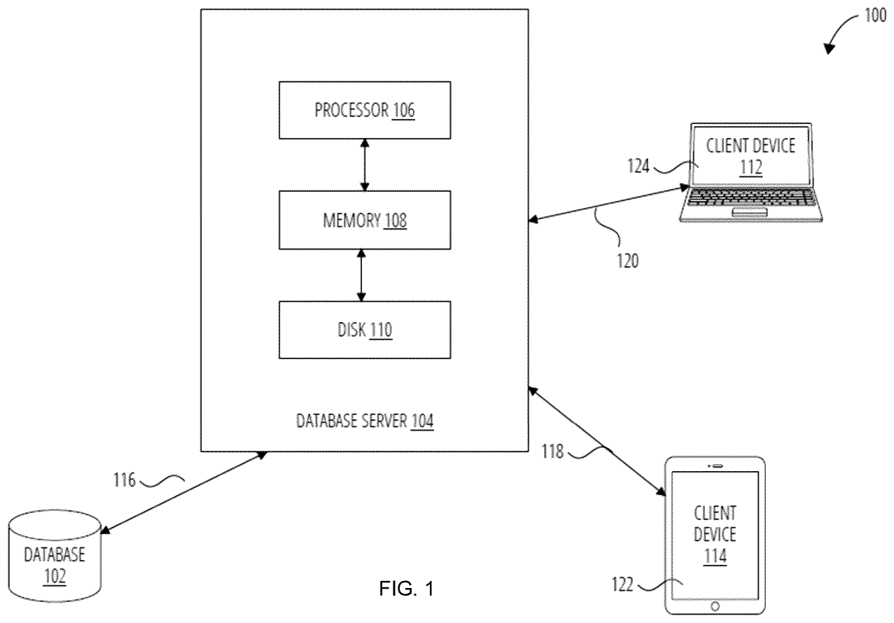

FIG. 1 illustrates an example of a system 100 for supply chain optimization.

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also comprise a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

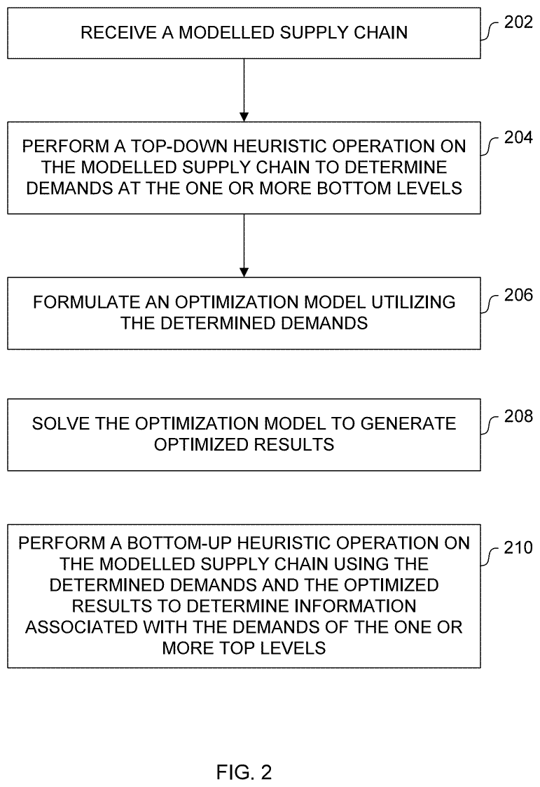

Referring now to FIG. 2, a flow chart illustrating an example computer implemented method for supply chain optimization is shown. The method may be performed by a system, such as, for example, the example system 100 described previously with reference to FIG. 1. The operations of the computer implemented method may be performed by a processor, such as, for example, the processor 106 of the example system 100 described previously. The processor may perform the computer implemented method by executing instructions stored on a memory, such as, for example, on one or more of the memory 108, the disk 110, and the database 102 of the example system 100 described previously.

At 202, a modelled supply chain is received. The modelled supply chain may comprise modelled supply chain data representing the supply chain being modelled. The modelled supply chain may include one or more finished or semi-finished goods at one or more top levels of the modelled supply chain. For each of the one or more finished or semi-finished goods, a complementary set of component products may be provided or included at one or more bottom levels of the modelled supply chain. The modelled supply chain may be received in any suitable manner, including retrieving the modelled supply chain from a memory or database.

The modelled supply chain may, in one embodiment, be configured into the one or more top levels and the one or more bottom levels. The processor may receive a modelled supply chain partitioned into the one or more finished or semi-finished goods at the one or more top levels, and the complementary one or more component products at the one or more bottom levels. For example, a user may partition the modelled supply chain into the one or more finished or semi-finished goods at the one or more top levels, and the complementary one or more component products at the one or more bottom levels. Such configuration may be performed prior to the modelled supply chain being received at 202.

At 204, a top-down heuristic operation is performed on the modelled supply chain to determine demands associated with the one or more bottom levels. The top-down heuristic operation may be performed by starting at the demands of the one or more finished or semi-finished goods at the one or more top-levels of the modelled supply chain and computing down to determine the demands at the one or more bottom levels that achieve the demands at the one or more top levels.

At 206, an optimization model is formulated for the one or more bottom levels of the modelled supply chain using the demands determined at 204. The optimization model may consist of, for example, decision variables, constraints, and an objective function. The decision variables may relate to, for example, one or more of supply quantities for each part and production method in each time period, use of substitute parts, and calculated safety stock levels. Constraints may relate to, for example, one or more of enforcing manufacturing capacities, inventory limits, and balancing relationships, to facilitate the lower-level components being available to create the higher-level supplies. The objective function may, for example, reduce, or minimize, a sum of weighted costs, which weighted costs may include, for example, manufacturing costs, inventory carrying costs, revenues, which may be represented as negative costs, and late demand satisfaction.

At 208, the optimization model is solved to generate optimized results. The optimization model may be solved, for example, by adjusting the decision variables to reduce, or minimize, the sum of the weighted costs.

At 210, a bottom-up heuristic operation on the modelled supply chain may be performed using the demands determined at 204 and the optimized results generated at 208. The heuristic operation at 210 may be performed to determine information associated with the demands and supplies of the one or more top levels of the modelled supply chain. The determined information may include, for example, satisfaction date, or supply allocations, or both, for the demands at the one or more top levels.

According to one or more embodiments, the present disclosure describes a system and method of supply chain optimization that includes a combination of heuristics at the top levels of the supply chain and optimization at the bottom levels of the supply chain. This approach may reduce computational requirements of the overall optimization process in the case of supply chains with numerous but simpler top-level products and with fewer, more complex, bottom-level components. Because the number of alternate solution paths are reduced at top levels compared to bottom levels, a sufficient approximation of the demands, suitable for use as a starting point in the optimization operation, is provided by determining demands using less computationally intensive heuristic operations. Optimization is then performed on a sub-set of the modelled supply chain, for example the bottom levels, rather than the entire supply chain, using the demands determined by the heuristic operation to simplify the formulating and solving of the optimization model. Such an approach may reduce the computational requirements of the optimization compared to global optimization solutions. Once the optimization at the bottom levels is carried out, a second heuristic operation may be performed, benefiting from the less complex structure of the modelled supply chain at the top levels. The second heuristics operation may be performed from bottom to top to accurately propagate the satisfaction dates and the supply allocations from the bottom levels to the demands at the top levels.

By utilizing both heuristics and optimization, the overall functioning of the computer system, such as the example system 100 described previously, may be improved by facilitating performing optimization of a supply chain using reduced computational resources, such as, for example, reduced computing time, reduced computer memory requirements, and reduced computer processor requirements, compared to a global solving approach while still producing comparable high-quality solutions. Such improvements and solutions to computer problems are achieved by the methods of one or more of the embodiments described and illustrated herein.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving, by a processor, a modelled supply chain having one or more finished or semi-finished goods at one or more top levels and, for each of the one or more finished or semi-finished goods, a complementary set of component products at one or more bottom levels;
performing, by the processor, a top-down heuristic operation on the modelled supply chain to determine demands and supplies at the one or more bottom levels;
formulating, by the processor, an optimized model for the one or more bottom levels based on the determined demands and supplies; and
solving, by the processor, the optimized model to generate optimized results.

2. The computer-implemented method according to claim 1, further comprising performing, by the processor, a bottom-up heuristic operation on the modelled supply chain using the determined demands and supplies and the optimized results to determine information associated with demands and supplies of the one or more top levels.

3. The computer-implemented method according to claim 2, wherein the information associated with the demands of the one or more top levels is the satisfaction date, or supply allocations, or both, for the demands and supplies at the one or more top levels.

4. A system comprising:
a processor; and
a memory storing instructions that, when executed by the processor, configure the system to:
receive, by the processor, a modelled supply chain having one or more finished or semi-finished goods at one or more top levels and, for each of the one or more finished or semi-finished goods, a complementary set of component products at one or more bottom levels;
perform, by the processor, a top-down heuristic operation on the modelled supply chain to determine demands and supplies at the one or more bottom levels;
formulate, by the processor, an optimized model for the one or more bottom levels based on the determined demands and supplies; and
solve, by the processor, the optimized model to generate optimized results.

5. The system according to claim 4, further comprising the memory storing instructions that, when executed by the processor, configure the system to perform, by the processor, a bottom-up heuristic operation on the optimized results to determine information associated with demands and supplies of the one or more top levels.

6. The system according to claim 5, wherein the information associated with the demands of the one or more top levels is the satisfaction date, or supply allocations, or both, for the demands and supplies at the one or more top levels.

7. A non-transitory computer-readable medium, the computer-readable medium including instructions that when executed by a computer, cause the computer to:
receive, by a processor, a modelled supply chain having one or more finished or semi-finished goods at one or more top levels and, for each of the one or more finished or semi-finished goods, a complementary set of component products at one or more bottom levels;
perform, by the processor, a top-down heuristic operation on the modelled supply chain to determine demands at the one or more bottom levels;
formulate, by the processor, an optimized model for the one or more bottom levels based on the determined demands; and
solve, by the processor, the optimized model to generate optimized results.

8. The non-transitory computer-readable medium according to claim 7, further including instructions that, when executed by the computer, cause the computer to perform, by the processor, a bottom-up heuristic operation on the optimized results to determine information associated with demands and supplies of the one or more top levels.

9. The non-transitory computer-readable medium according to claim 7, wherein the information associated with the demands of the one or more top levels is the satisfaction date, or supply allocations, or both, for the demands and supplies at the one or more top levels.
